(19) United States
(12) Patent Application Publication
(10) Pub. No.: US 2024/0405588 A1
(43) Pub. Date: Dec. 5, 2024

(54) CHARGING ASSEMBLY FOR ORAL HEALTH DEVICES

(71) Applicant: WATER PIK, INC., Fort Collins, CO (US)

(72) Inventors: Blaine HANSEN, Fort Collins, CO (US); Dane SPRISTER, Fort Collins, CO (US)

(73) Assignee: WATER PIK, INC., Fort Collins, CO (US)

(21) Appl. No.: 18/698,088

(22) PCT Filed: Sep. 16, 2022
(86) PCT No.: PCT/US22/43803

§ 371 Date: Apr. 3, 2024

Related U.S. Application Data
(60) Provisional application No. 63/255,162, filed on Oct. 13, 2021.

(51) Int. Cl. H02J 7/00; A61C 17/22

(52) U.S. Cl. CPC H02J 7/007188; A61C 17/224; H02J 7/00302; H02J 7/0036; H02J 7/0048

(57) ABSTRACT

A charging assembly for an oral health device is disclosed. The charging assembly includes a first coupling end including an electrical contact configured to electrically connect to a battery of the oral health device; a second coupling end including an electrical contact configured to electrically connect to a power source; and a controller position between the first coupling end and the second coupling end and electrically coupled to the first coupling end and the second coupling end, wherein the controller selectively enables current to flow from the second coupling end to the first coupling end.

### TECHNICAL FIELD

One or more embodiments of the present disclosure relate generally to charging assemblies, such as electrical connectors, including charging cords, charging assemblies, and electrical connectors, for oral health devices.

### BACKGROUND

Oral health devices, such as oral irrigators, electric toothbrushes, and combination units, often require a power source in order to power a motor to activate a brush motion and/or pump for fluid expulsion. Often, the power source may be a battery or other portable electricity storage element that needs to be recharged as power is used by the oral health device. Many consumers may leave the oral health device coupled to the charger for extended periods of time, such as days or months. Conventional charging assemblies for oral health devices may continue to provide power to the battery as long as the charging assembly is connected, which can waste power and damage the battery. Further, many oral health devices may require outdated electrical connections for the charging assembly, which may prevent users from utilizing newer technologies, such as universal serial bus connectors. As such, there is a need for improved charging assemblies for oral health devices.

### SUMMARY

In one embodiment, a charging assembly for an oral health device is disclosed. The charging assembly includes a first coupling end including an electrical contact configured to electrically connect to a battery of the oral health device; a second coupling end including an electrical contact configured to electrically connect to a power source; and a controller position between the first coupling end and the second coupling end and electrically coupled to the first coupling end and the second coupling end, wherein the controller selectively enables current to flow from the second coupling end to the first coupling end.

In another embodiment, a method for charging an oral health device is disclosed. The method includes determining that a battery for the oral health device is electrically coupled to charging assembly; enabling a current flow from a power source to the battery via the charging assembly; and determining that a charge time has elapsed and disabling the current flow from the power source to the battery.

In yet another embodiment, a charger for an oral health device is disclosed. The charger may include a first a first plug to couple to a socket of the oral health device and electrically couple to a battery within the oral health device; a second plug to couple to a power source; and a state machine circuit configured to selectively enable current to flow from the power source to the battery based on a charge state or a drain state of the battery.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the charging assembly described herein and should not be construed as a complete depiction of the scope of the charging assembly.

FIG. 1 is a isometric view of an oral health system including an oral health device and a charging assembly in accordance with embodiments of the disclosure.

FIG. 2 is a front isometric view of a charging assembly in accordance with embodiments of the disclosure.

FIG. 3 is an exploded view of the charging assembly in accordance with embodiments of the disclosure.

FIG. 4 is a partially exploded view of the charging assembly in accordance with embodiments the disclosure.

FIG. 5 is a schematic of a controller in accordance with embodiments of the disclosure.

FIG. 6 is a flow chart illustrating a method of charging a device with a charging assembly in accordance with embodiments of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

According to the present disclosure, a charging assembly, which may be detachable from a device to be charged, is disclosed. The charging assembly may be used with various types of devices that require electrical power, such as, but not limited to, oral health devices including oral irrigators, electrical toothbrushes, and combination irrigators/brushes, as well as other types of powered consumer products and devices. In one example, the charging assembly may act to couple the oral health device to an electrical connector, such as a Universal Serial Bus (USB) connector, even if the oral health device was originally designed for other types of electrical connectors. For example, the charging assembly may include a first coupling end that can mechanically and electrically couple to the oral health device and a second coupling end that mechanically and electrically couple to a USB or other type of port, where the first and second coupling ends may have different coupling protocols or structures from one another. In this manner, the charging assembly may allow backwards compatibility for the device to be charged with improved charging technologies.

In some instances, the charging assembly may be configured to limit power consumption by the oral health device, which may help to save power and reduce over charging of a battery for the oral health device. For example, the charging assembly may include a controller that may reduce or limit current from a power source to the first coupling end of the charging assembly once a charging time has elapsed, e.g., after the battery has been fully charged. In this manner, the charging assembly may reduce power waste and may prevent the battery from being over charged.

As many oral heath devices may remain “plugged in” even after fully charged, the charging assembly may also be configured to initiate a recharge after a drain period. For example, in instances where the charging assembly has remained coupled to the battery of the oral health device for a length of time corresponding to a drain period for the battery (e.g., time sufficient for the battery charge to dissipate or drain), the charging assembly will initiate charging to recharge the battery. The ability to both limit overcharging, while allowing the charging assembly to remain plugged into or coupled to the oral health device, while also ensuring that the battery will have sufficient power to operate the oral health device at a given time, helps to both save power, enable a good user experience, and prevent battery damage.

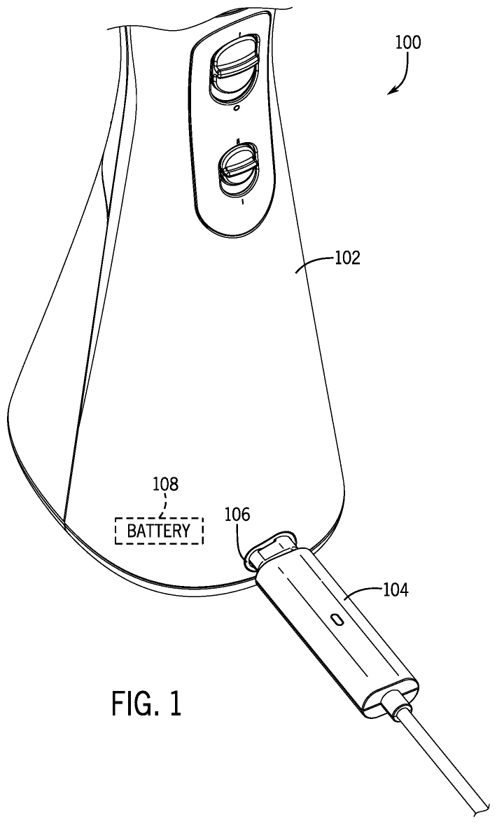

Turning to the figures, FIG. 1 illustrates a perspective view of a charging system 100, including a device 102 and a charging assembly 104 for charging the device 102 or otherwise providing power directly to the device 102 (e.g., directly to a motor rather than to a battery). In one example, the device 102 is an oral health device, such as an oral irrigator, toothbrush, or combination unit, but in other embodiments may be any other type of consumer product or device requiring power. In instances where the device 102 is an oral irrigator, the charging connector 104 may provide power to a battery 108 that supplies power to a motor that drives a pump to expel fluid into a user's mouth. In instances where the device 102 is a toothbrush or a combination oral irrigator/brushing device, the charging connector 104 may provide power to the battery 108 that provides power to a motor that activates a vibration or brush motion (e.g., oscillates a brush head).

The device 102 includes a charging port 106 or socket that corresponds to and receives the charging assembly 104. For example, as shown in FIG. 1, in this example, the charging port 106 may be defined as a recessed cavity within a sidewall of an outer housing of the device 102. The charging port 106 may include one or more electrical contacts that when connected to the charging assembly 104 complete a circuit to allow the transfer of an electrical current from the charging assembly 104 to the corresponding component, e.g., battery 108, within the device 102. For example, the charging port 106 may be electrically connected to the battery 108, motor, circuit, processing element, or the like, within the device 102, such that once an electrical connection is made with the charging assembly 104 and current flow is initiated by the charging assembly 104, the connected internal components within the device 102 receive electrical current. It should be noted that in some instances, the device 102 may include one or more power converters or the like that transform the input power into a desired format or level satisfactory for the device 102. Alternatively, or additionally, the charging assembly 104 may include power transformers. Also, it should be noted that while the embodiments herein are discussed as providing power to the battery 108, in other instances, the charging assembly 104 may provide power directly to the power consuming element, such as the motor, within the device 102.

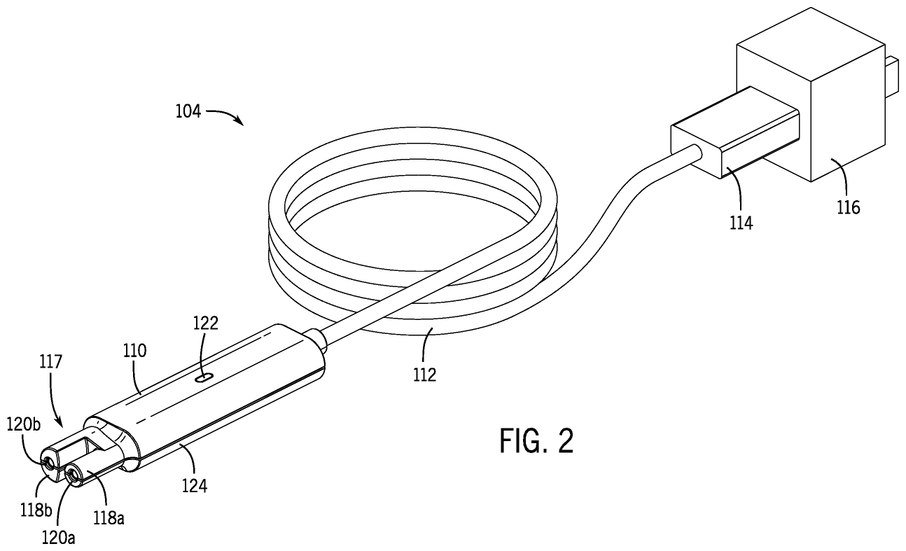

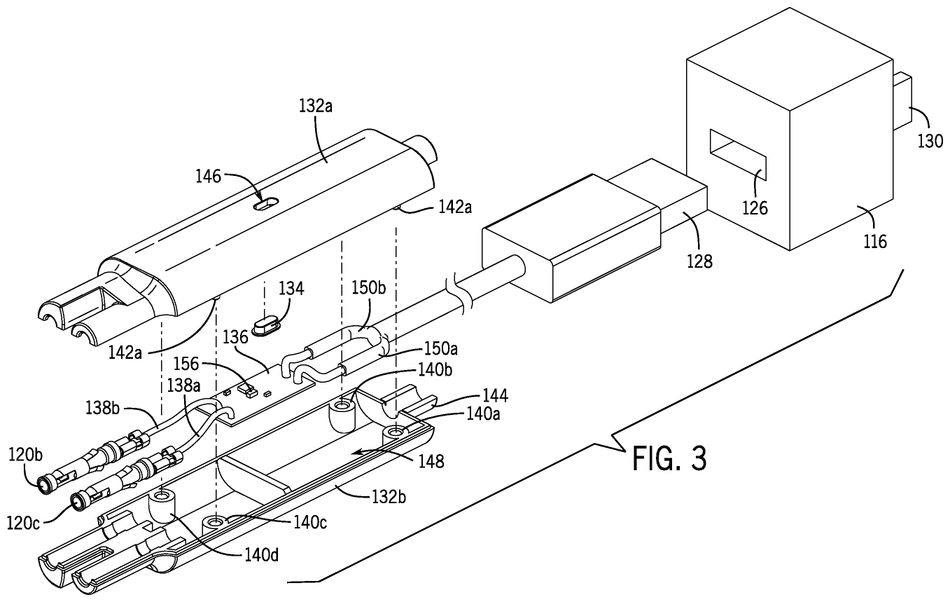

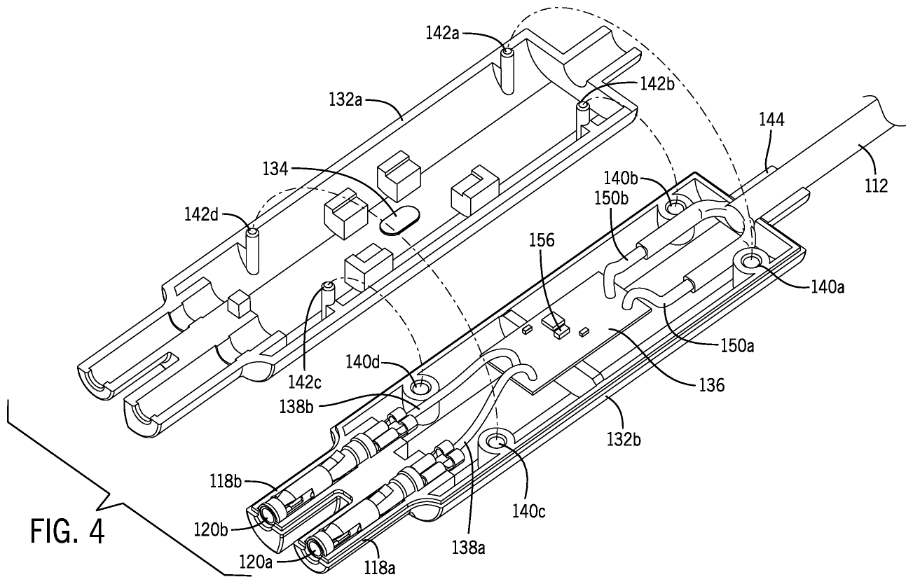

FIGS. 2-4 illustrate various views of the charging assembly 104. As shown, the charging assembly 104 may include a cable 112 that extends between a charger 110 and a plug or second coupling end 114. The cable 112 or power cord may include one or more electrical wires 150a, 150b or conductors and optionally may be wrapped with an insulator.

The second coupling end 114 may include an electrical connector, which may be configured to mechanically and electrically couple to a power source. In one example, the second coupling end 114 may be in the form of a universal serial bus (USB) plug and be configured to mate with USB compatible sockets or ports. In one example, the charging assembly 104 may include a power converter 116 which may include a set of prongs 130 extending from a first surface and a coupling port 126, which may be a USB port, on the second side. In this example, the converter 116 may electrically couple the second coupling end 114 to a power source, such as a wall outlet, or the like. However, in other embodiments, the second coupling end 114 may be configured to directly couple to a power source, such as a USB outlet, which may be formed as part of a wall outlet or coupled to a device (e.g., electronically powered device that can supply power to the connector assembly 104).

With continued reference to FIGS. 2-4, the charger 110 may be coupled to a first end of the cable 112. The charger 110 may define a first coupling end 117 for the charging assembly 104 and may be electrically positioned between the second coupling end 114 and the first coupling end 117 and configured to selectively allow current flow between the two ends 114, 117. It should be noted that in some embodiments, the second coupling end 114 may be coupled to or formed on the opposite side of the charger 110 from the first coupling end 117. For example, in instances where the cable 112 may be omitted, the second coupling end 114 may be coupled directly to the charger 110, rather than through the cable 112 as shown in FIGS. 2-4. Additionally, in some embodiments, the first coupling end 117 may correspond to a first type of electrical connector and the second coupling end 114 may correspond to a second type of electrical connector, where the second coupling end 114 transforms the first coupling end 117 to allow compatibility with different types of connection assemblies, including USB.

The first coupling end 117 may include one or more electrical and/or mechanical connectors, such as prongs 118a, 118b that may define a male connection for the connector assembly 104 to the device 102. However, in other embodiments, the first coupling end 117 may be configured as a female connection and the electrical and/or mechanical connection may be defined as one or more recesses, e.g., a socket. In one example, the prongs 118a, 118b may extend from the front or first end of the charger 110 may optionally include keying structures, such as differently shaped or sized prongs 118a, 118b to help align the first coupling end 117 within the port 106 of the device 102. For example, the second prong 118b may have a non-circular or flat side and be slightly larger in diameter from the first prong 118a, however, in other implementations other alignment or coupling structures may be used. It should be noted that the prongs 118a, 118b may define a mechanical connection to mechanically couple the charging assembly 104 to the device 102, as well as define an electrical connection to electrically couple the charging assembly 104 to the device 102.

A charger housing 124 may define an enclosure for components of the charger 110 and may also define mechanical structures, such as the mechanical components of the first coupling end 117. In one example, the charger housing 124 may include a first housing shell 132a and a second housing shell 132b that may be coupled together to define a housing compartment 148. To that end, in some embodiments, the shells 132a, 132b may include securing features 140a, 140b, 140c, 140d, 142a, 142b, 142c, 142d that interact together to align and optionally secure the shells 132a, 132b together. For example, the securing features 140a, 140b, 140c, 140d, 142a, 142b, 142c, 142d may include post and recess elements that engage to couple the shells 132a, 132b together. However, in other embodiments, tabs, adhesive, or other coupling elements may be used as well.

In some embodiments, the first shell 132a of the housing 124 may include an aperture 146, which may be configured to receive a light cover 134 therethrough. A nub 144 may extend from the rear or second side of the housing 124, which may act as a strain preventer to help prevent the cable 112 from bending adjacent the hosing 124.

A controller 136 or control module may be positioned within the housing 124 and may be electrically coupled to the cable 112 and the first coupling end 117. For example, the controller 136 may be coupled between wires 138a, 138b or electrical contacts that define the prong contacts 120a, 120b to electrically connect to the device 102 and wires 150a, 150b or electrical connections that couple to or define part of the cable 112 (e.g., couple to the second coupling end 114). In this manner, the controller 136 can selectively control current flow between the first coupling end 117 and the second coupling end 114, as discussed in more detail below. The controller 136 may include a circuit board, such as a printed circuit board, as well as one more control or electrical components that can selectively disconnect or connect the first coupling end 117 to the second coupling end 114.

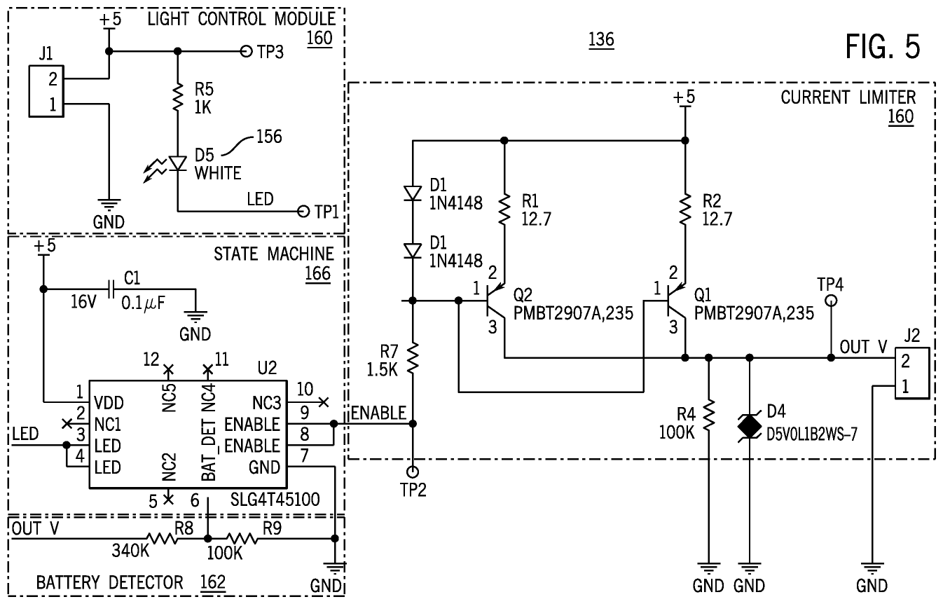

FIG. 5 illustrates a schematic of one embodiment of the controller 136. It should be noted that although FIG. 5 illustrate specific electrical components, such as resistors, transistors, capacitors, and the like, similar functionality as described herein may be achieved with different electrical component arrangements and as such the configuration of FIG. 5 is meant as illustrative only. The various features of the controller 136 as shown in the schematic in FIG. 5 may be mounted to a substrate, such as a circuit board, and electrically connected via wire traces, contact pads, wires, or the like.

A light control module 160 which may control activation of a status light, such as a light emitting diode (LED) 156 may be included in the controller 136. The light control module 160 selectively provides power to the LED 156, such as to indicate the start and/or end of charging for the device 102. For example, when the controller 136 is charging the battery 108, the light control module 160 activates the LED 156 and deactivates the LED 156 when the controller 136 is not charging the battery 108.

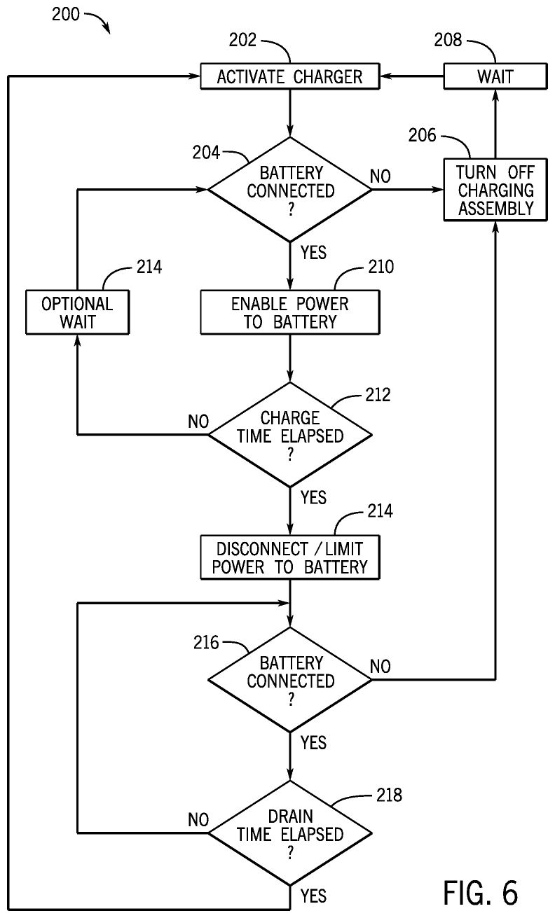

A state machine 166 or state module may determine when to enable current flow from the second coupling end 114 to the first coupling end 117 or otherwise provide power to the device 102. The state machine 166 may include various features, such as one or more timing elements that can determine a charge time, a drain time, and other time periods and whether such periods have elapsed as discussed in more detail below. In some embodiments, the state machine 166 may be in the form of an analog circuit, where decisions may be based on sequential logic functional components, but in other embodiments, the state machine 166 may include a micro controller, processing element, or the like, and utilize software to execute the functionality. In some embodiments, the state machine 166 may include memory or other storage components may store information, such as information related to charging or timing periods, or the like. In other embodiments, the memory may be omitted and instead sequential logic may be used. Examples of the specific logic or decisions made by the state machine 166 are discussed in more detail with respect to FIG. 6.

A battery detector 162 or load verifier may be electrically coupled to the state machine 166. In one embodiment, the battery detector 162 may be a voltage divider that analyzes a load coupled to the controller 136, e.g., at the first coupling end 117, to determine whether there is a battery or other electrical consumption component electrically coupled to the controller 136. For example, the battery detector 162 may be configured to detect a voltage drop when the electrical contacts 120a, 120b of the first coupling end 117 are coupled to the battery 108 in the device 102. However, in other embodiments, different detection characteristics may be used to detect whether the first coupling end 117 is coupled to the battery 108.

With continued reference to FIG. 5, the controller 136 may also include a current limiter 164. The current limiter 164 is configured to selectively reduce or prevent current from flowing to the electrical contacts 120a, 120b in the first coupling end 117. For example, the current limiter 164 may use one or more transistors to limit the current flow provided to the contacts 120a, 120b via the controller 136. In one example, the current limiter 164 may be activated or deactivated by the state machine 166 and may be electrically coupled thereto. For example, an enable signal may be provide by the state machine 166 based on one or more charging states, discussed in more detail below.

With reference again to FIGS. 2-4, the controller 136 may be assembled, e.g., the various components electrically coupled together, and may then be electrically connected to the first coupling end 117 and second coupling end 114. For example, wires 138a, 138b or electrical contacts may be coupled to the controller 136 and may extend to or be formed into the electrical contacts 120a, 120b for the prongs 118a, 118b. Similarly, wires 150a, 150b or electrical contacts may be coupled from the controller 136 to the cable 112 or in some instances the second coupling end 114 and specifically the electrical contact 128.

The controller 136 and electrical connections may be positioned within the housing compartment 148 and the housing shells 132a, 132b may be secured together. For example, the securing and alignment features 140a, 140b, 140c, 140d, 142a, 142b, 142c, 142d, may be aligned and secured together, securing the housing shells 132a, 132b in position. It should be noted that the electrical contacts 120a, 120b for the prongs 118a, 118b may remain exposed even after the housing 124 is secured over the controller 136. Additionally, the LED 156 may be aligned with the aperture 146 in the housing and the cover 134 may be positioned over the LED 156 and positioned within the aperture 146. In this manner, light emitted from the LED 156 may be visible from an exterior of the charger assembly 104.

With reference to FIG. 1, to charge the device 102, the user orients the first coupling end 117 towards the port 106 and inserts the prongs 118a, 118b into the port 106 of the device 102. The electrical contacts 120a, 120b of the prongs 118a, 118b then couple to corresponding contacts (not shown) within the device 102. The connection may then complete an electrical circuit between the battery 108 and the charging assembly 104. The charging assembly 104 may then provide current from the power source, e.g. wall outlet, coupled to the second coupling end 114 to the battery 108. As the charging assembly 104 is activated and providing current to the battery 108, the light control module 160 illuminates the LED 156 providing feedback to the user regarding the active charging state of the charging assembly 104. In some instances, the charging assembly 104 may selectively prevent current flow, which may help prevent over charging of the battery 108, while also helping to ensure that the battery 108 has a sufficient charge and the device 102 is ready to use at any given time. In these instances, the light control module 160 may deactivate the LED 156 to provide feedback to the user that charging has completed or is otherwise not active.

FIG. 6 illustrates an method 200 for charging the device 102 via the charging assembly 104. The method 200 may begin with operation 202 and the charging assembly 104 may be activated. For example, the charging assembly 104 may activate the controller 136 to allow current to flow from the power source to the first coupling end 117 to be able to detect whether the device 102 is electrically coupled thereto. In one example, the state machine 166 may be configured to sense a signal from the battery detector 162.

In operation 204, it may be determined whether a battery 108 or other load is electrically connected to the charging assembly 104. For example, the battery detector 162 output may be analyzed to determine whether there is a voltage drop at the voltage output which may indicate that the battery 108 is electrically coupled to the charger 110 of the charging assembly 104.

If a battery 108 or other load is not detected, the method 200 proceeds to operation 206 and the charging module or controller 136 is deactivated. For example, the current limiter may be activated and current flow may be reduced or stopped to the first coupling end 117. Optionally, a wait operation 208 may be completed before the method 200 returns to operation 202. For example, in some implementations, the charging assembly 104 may “ping” or check for the device 102 being coupled at a select interval (e.g., activate current flow to the first coupling end 117 to allow detection of a load) which may be predetermined or random. In one embodiment, the wait operation 208 may be approximately once every second or every couple of seconds, such that the charging assembly 104 may check for a connection to the device 102 every second. For example, the controller may include a clock that may be used to determine the various time frames if wait operations are utilized.

If in operation 204 a battery 108 or other load is detected, the method 200 proceeds to operation 210 and current flow to the battery 108 is enabled or continued. For example, the controller 136 may electrically connect the contacts 120a, 120b (coupled to the battery 108) to the current source coupled to the prongs 130 of the converter 116 or otherwise coupled to the contact 128 at the second coupling end 114. In these instances, the current limiter 164 may be configured to allow almost all or all of the current from the source at the second coupling end 114 to reach the contacts 120a, 120b at the first coupling end 117.

After coupling of the battery 108 to the power source, the method 200 proceeds to operation 212 and the controller 136 determines whether a charge time has elapsed or been surpassed. For example, the state machine 166 may determine whether the time period, which may be preset, has elapsed while the battery 108 has been coupled to the charger 110. In one example, the charge time may correspond to an estimated time to fully charge the battery 108 from a fully depleted state. In other instances, the charge time may correspond to a time to charge the battery 108 to another level, e.g., 75% charged or 85% charged. Additionally, while in some instances the charge time may be predetermined or set, in other instances, the charge time may be dynamic or variable. In some embodiments, the charge time may be selected based on the battery 108 that the charging assembly 104 is configured to be used to charge. In other words, the charge time may be correlated to or correspond to the battery 108, including the battery 108 size, type, and current level.

If the charge time has not yet elapsed, the method 200 may proceed to operation 214 and the controller 136 may optionally wait for a period of time. After operation 214 or until the charge time has elapsed in operation 212, the method 200 returns to operation 204 and determines whether the battery remains connected. For example, the charging assembly 104 may cease charging after the battery 108 has been disconnected, even if the charging time has not yet elapsed. In one implementation, the battery 108 must be connected and the charging time not yet elapsed for the controller 136 to continue to provide power to the electrical contacts 120a, 120b.

With continued reference to FIG. 6, in operation 212, once the charge time has elapsed or expired, the method 200 may proceed to operation 214 and the controller 136 may limit or disconnect the battery 108 from the power source. For example, the controller 136 may activate the current limiter 164 to restrict or prevent current flow from the second coupling end 114 to flow to the contacts 120a, 120b of the first coupling end 117, effectively preventing current flow to the battery 108 (e.g., disable current flow). As one example, the current limiter 164 may provide activate a saturation mode for one or more transitions, that act to prevent current from flowing to the contacts 120a, 120b, despite the second coupling end 114 receiving power from the power source. In other instances, the controller 136 may limit current in other manners, such as including an mechanical switch or the like that may decouple the contacts 120a, 120b from the power source.

After the current flow has been discontinued, the method 200 may proceed to operation 216 and the controller 136 may determine whether a battery 108 is reconnected. For example, the controller 136 may allow current flow to the first coupling end 117 and utilize the battery detector 162 to determine whether there is a load, such as the battery 108, recoupled to the charging assembly 104. If the battery 108 is not connected, the method 200 may return to operation 206 and the charging assembly 104 may deactivate or turn off current flow to the battery 108 before awaking again, allowing current flow to determine if the battery 108 has been detected.

If in operation 216 the battery 108 is coupled to the charging assembly 104, the method 200 may proceed to operation 218 and the controller 136 may determine whether a drain time has elapsed. For example, the drain time may correspond to a length of time for the battery to fully or substantially deplete from full charge without use. As one example, the drain time may correspond to a time of 5 to 30 days and sometimes may correspond to a time between 7 and 10 days, but depends on the battery size and type. If the drain time has not elapsed, the method 200 may return to operation 216 with an optional wait period before proceeding. If, on the other hand, the drain time has lapsed, the method 200 may return to operation 202 and the battery 108 may be recharged, e.g., current may be provided from the power source to the contacts 120a, 120b to charge the battery 108.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A charging assembly for an oral health device comprising:
a first coupling end including an electrical contact configured to electrically connect to a battery of the oral health device;
a second coupling end including an electrical contact configured to electrically connect to a power source; and
a controller position between the first coupling end and the second coupling end and electrically coupled to the first coupling end and the second coupling end, wherein the controller selectively enables current to flow from the second coupling end to the first coupling end.

2. The charging assembly of claim 1, wherein the controller selectively enables current to flow based on whether a connection between the first coupling end and the battery of the oral heath device has surpassed a charge time.

3. The charging assembly of claim 1, wherein the controller selectively enables current to flow based on whether a connection between the first coupling end and the battery of the oral health device has surpassed a drain time.

4. The charging assembly of claim 1, wherein the controller restricts current flow after a charge time has elapsed and before a drain time has elapsed.

5. The charging assembly of claim 4, wherein the controller restarts a charge time when the first coupling end is disconnected from the battery.

6. The charging assembly of claim 1, wherein the second coupling end comprises a universal serial bus plug.

7. The charging assembly of claim, 6, wherein the first coupling end is a non-universal serial bus plug.

8. The charging assembly of claim 1, further comprising a status indicator electrically coupled to the controller, wherein the status indicator illuminates when the controller enables current to flow from the second coupling end to the first coupling end.

9. The charging assembly of claim 1, wherein the controller comprises:
a current limiter that reduces current flow from the second coupling end to the first coupling end.

10. The charging assembly of claim 1, wherein the controller comprises a load detector electrically coupled to the first coupling end and configured to detect that the battery is electrically coupled to the first coupling end.

11. The charging assembly of claim 1, wherein the controller comprises a state machine to determine whether to enable or disable current flow.

12. A method for charging an oral health device comprising:
determining that a battery for the oral health device is electrically coupled to charging assembly;
enabling a current flow from a power source to the battery via the charging assembly; and
determining that a charge time has elapsed and disabling the current flow from the power source to the battery.

13. The method of claim 9, further comprising:
determining that the battery has remained electrically coupled to the charging assembly for a drain time; and
re-enabling the current flow from the power source to the battery.

14. The method of claim 10, wherein the drain time is longer than the charge time.

15. The method of claim 10, wherein the charge time corresponds to a time to fully charge the battery and the drain time corresponds to a time to deplete the battery.

16. The method of claim 9, wherein the charging assembly comprises an analog controller configured to enable the current flow and determine that the charge time has elapsed.

17. A charger for an oral health device comprising:
a first plug to couple to a socket of the oral health device and electrically couple to a battery within the oral health device;
a second plug to couple to a power source; and
a state machine circuit configured to selectively enable current to flow from the power source to the battery based on a charge state or a drain state of the battery.

18. The charger of claim 17, wherein the charge state is determined based on a time elapsed for a current flow from the power source to the battery.

19. The charger of claim 17, wherein the drain state is determined based on a time elapsed without a current flow from the power source to the battery while the first plug has remained electrically coupled to the battery.

20. The charger of claim 17, further comprising a controller, wherein the state machine circuit forms a portion of the controller, and the controller further comprises:
a current limiter to disable the current flow; and
a battery detector configured to detect that the battery is electrically coupled to the first plug.
